(19) United States
(12) Patent Application Publication
(10) Pub. No.: US 2005/0051602 A1
(43) Pub. Date: Mar. 10, 2005

(54) Control system for friction stir welding of metal matrix composites, ferrous alloys, non-ferrous alloys, and superalloys

(76) Inventors: Jonathan Allyn Babb, Provo, UT (US); Troy Connolly, Lehi, UT (US); Russell J. Steel, Salem, UT (US); Scott M. Packer, Alpine, UT (US); Tracy W. Nelson, Provo, UT (US); Carl D. Sorensen, Provo, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/846,825

(22) Filed: May 13, 2004

Related U.S. Application Data
(60) Provisional application No. 60/469,964, filed on May 13, 2003.

(51) Int. Cl. B23K 20/12

(52) U.S. Cl. 228/112.1; 228/2.1

(57) ABSTRACT

A control system and method of use that enables friction stir welding of metal matrix composites, ferrous alloys, non-ferrous alloys, and superalloys when using a superabrasive tool, wherein the control system and method enables control of various operational aspects of a friction stir welding mill in order to make it possible to perform friction stir welding that is repeatable, reliable, and results in a superior finished workpiece.

### Cross Reference TO RELATED APPLICATIONS

This document claims priority to, and incorporated by reference all of the subject matter included in the provisional patent application docket number 2704.5MII.PR, having Ser. No. 60/469,964 and filed on May 13, 2003.

### BACKGROUND OF THE INVENTION

1. Field of the Invention

This invention relates generally to friction stir welding wherein heat for creating a weld is generated by plunging a rotating pin of a tool into a workpiece. More specifically, the present invention relates to a control system and a method of use in a friction stir welding process that enables the present invention to weld materials that are not functionally weldable using state of the art friction stir welding processes and tools, said materials including ferrous alloys such as stainless steel, and higher melting point superalloys that contain only small amounts of or no ferrous materials at all.

2. Description of Related Art

The state of the art in control systems for performing friction stir welding have proven inadequate for friction stir welding of metal matrix composites, ferrous alloys, non-ferrous alloys, and superalloys when using a superabrasive tool. The fact that the control systems for friction stir welding of softer materials were inadequate surprised the inventors. Solutions only came to light after significant experimentation and development that has required substantial innovation in techniques and equipment in order to resolve the problems and make the friction stir welding of metal matrix composites, ferrous alloys, non-ferrous alloys, and superalloys a viable process.

A typical friction stir welding system 8 of the prior art is illustrated in FIG. 1. FIG. 1 indicates that the system is comprised of a frame 10, a table 12 for supporting the workpieces 14 that are being welded together using friction stir welding, an arm 16 that extends outward from the frame 10 and over the workpieces 14, a tool holder 18, and a tool 20 that has been inserted into the tool holder. This system is typical of those that are used for the friction stir welding of relatively planar workpieces.

There are several problems that had to be overcome in order to accomplish friction stir welding as taught in this document. These problems include: 1) an uneven weld on the top of the workpieces, 2) a weld that contains holes, 3) a weld that does not have consistent and full penetration of the workpieces, 4) a repeatable friction stir welding process that enables assembly-line type of consistency, 5) irregular welds because of inaccurate control of the speed of rotation of the tool, 6) uneven tool temperature during the friction stir welding process, and 7) unnecessary wear of and thus shortening of the useful life of the tool.

Accordingly, what is needed is a complete and coordinated system and method for overcoming all of these problems in order to make friction stir welding a viable process.

### BRIEF SUMMARY OF THE INVENTION

It is an object of the present invention to provide a system and method that enables friction stir welding of MMCs, ferrous alloys, and superalloys, as well as non-ferrous alloys.

It is another object to provide a system and method that enables friction stir welding having an even weld on the top of the workpieces.

It is another object to provide a system and method that enables friction stir welding characterized by the absence of holes in the weld.

It is another object to provide a system and method that enables friction stir welding that produces a weld that has consistent and full penetration of the workpieces.

It is another object to provide a system and method that enables a repeatable friction stir welding that enables assembly-line type of consistency.

It is another object to provide a system and method that enables friction stir welding of regular welds by accurate control of the speed of rotation of the tool.

It is another object to provide a system and method that enables friction stir welding by improved control over tool temperature during the friction stir welding process.

It is another object to provide a system and method that enables friction stir welding by a process that improves the wear and increases the useful life of the tool.

In a preferred embodiment, the present invention is a control system and method of use that enables friction stir welding of metal matrix composites, ferrous alloys, non-ferrous alloys, and superalloys when using a superabrasive tool, wherein the control system and method enables control of various operational aspects of a friction stir welding mill in order to make it possible to perform friction stir welding that is repeatable, reliable, and results in a superior finished workpiece.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a profile view of the basic components of a friction stir welding system.

FIG. 2 is cut-away profile view of the inside of the workpieces and the profile of the tool in the workpieces.

FIG. 3 is a profile view of the elements of one aspect of the present invention embodied in a friction stir welding mill.

FIG. 4 is a profile cut-away view of a laser measurement system used with the friction stir welding mill of the present invention.

FIG. 5 is a flowchart of a method of using a FIFO in the measurement system.

FIG. 6 is a flowchart of a method of performing an Auto Touch-off Sequence.

FIG. 7 is a block diagram of a system for decreasing response time when controlling the spindle motor of the tool.

FIG. 8 is a flowchart of a method of monitoring temperature to determine of the tool and then increasing or decreasing rotational speed to decrease temperature of the tool.

FIG. 9 is a flowchart of a method of monitoring the system for anomalies that would require closer inspection of workpieces.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a friction stir welding control system and method that makes it possible to friction stir weld metal matrix composites, ferrous alloys, non-ferrous alloys, and superalloys when using a superabrasive tool. Without these improvements to the control system and method, friction stir welding of metal matrix composites, ferrous alloys, non-ferrous alloys, and superalloys when using a superabrasive tool will not be practical or reliable.

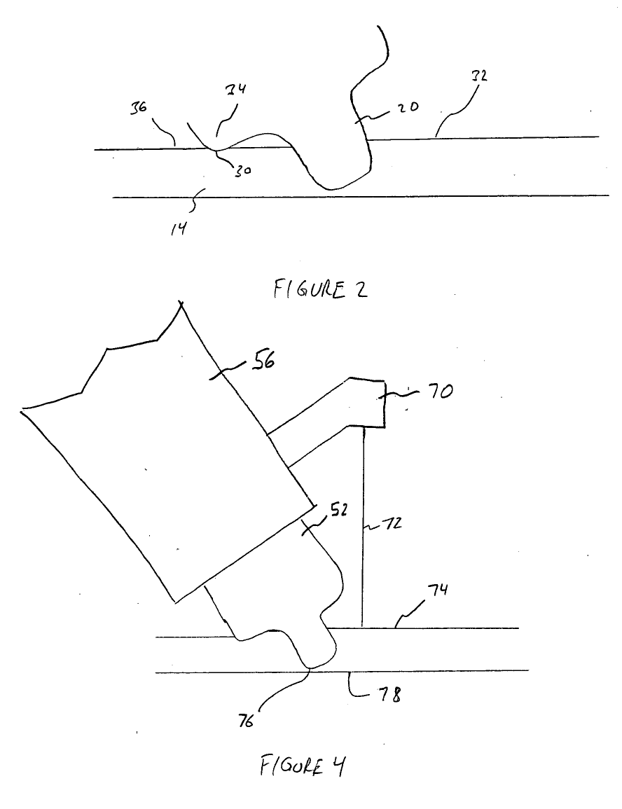

The first aspect of the present invention is referred to as z-axis force control during the friction stir welding process. FIG. 2 is provided to illustrate a tool of the present invention that is friction stir welding two workpieces comprised of metal matrix composites, ferrous alloys, non-ferrous alloys, or superalloys. Z-axis force is the pressure exerted by the tool 20 on the workpieces 14. In a typical friction stir welding process, the tool 20 is pressed down upon the workpieces 14 such that the trailing edge 30 of the tool is slightly below the pre-joined surface 32 of the workpieces as shown in FIG. 2. In other words, a shoulder 34 of the tool 20 is typically being pressed into the workpieces 16.

It should be remembered that FIG. 2 shows exaggerated sizes and shapes in order to illustrate the concept being explained. By pressing the shoulder 34 of the tool 20 into the workpieces 14, a slight depression or trough 36 is left by the tool shoulder. Thus, the trough 36 is typically below a level of the pre-joined surface 32 of the workpieces 14.

What is important to understand is that if the z-axis force is not more precisely controlled, the resulting weld is typically uneven. In addition, the trailing edge 30 creates the trough 36 that will have holes and irregularities because the weld is not “healing” itself as the shoulder 34 passes over the weld joint between the workpieces 14. Finally, tools have been known to break because of unexpected variations in z-axis force.

It has been determined that consistent z-axis force enables the creation of a consistent weld without irregularities and holes. The reason that inconsistent z-axis force is applied by any prior art friction stir welding system 8 are many, and include inconsistencies in the workpieces, thermal expansion of the workpieces, thermal expansion of the tool, and the fact that the friction stir welding mill 8 itself is not a perfect machine.

Consistent z-axis force is made possible by including a dynamometer in the friction stir welding mill. A dynamometer enables precise measurement of forces being applied to the workpieces 14 by the tool 20, thus enabling the friction stir welding mill to make small adjustments as required to make the applied force consistent. The placement of a dynamometer within the friction stir welding mill is not a critical element of the invention. What is important is that the dynamometer be installed for use in the mill such that the dynamometer can measure the force of the tool on the workpieces, which is clearly not being done by those skilled in the art.

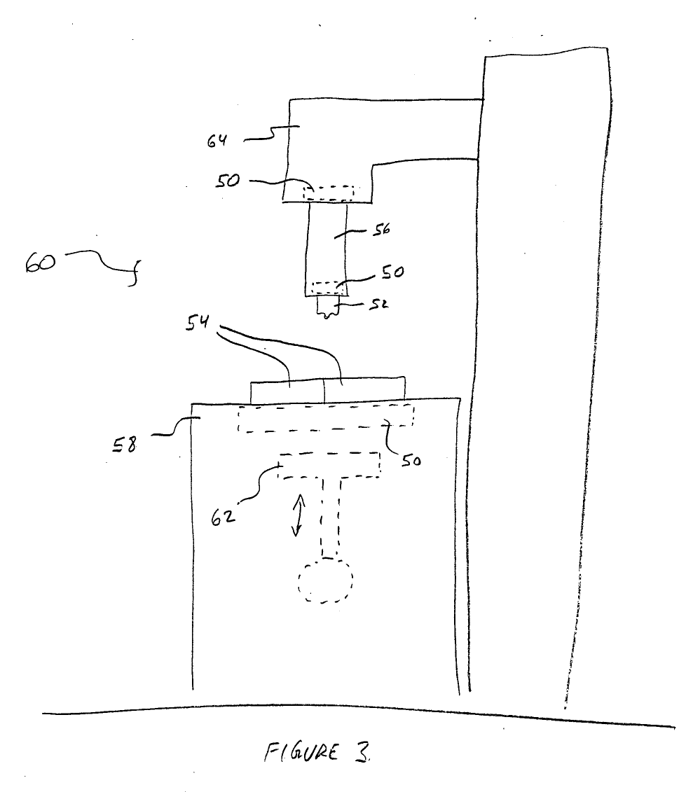

FIG. 3 is provided as an illustration of a friction stir welding mill 60 that is made in accordance with the principles of the present invention that includes at least one dynamometer 50 for measuring forces applied by a tool 52 to workpieces 54. The actual size and location of the dynamometers 50 can vary from what is illustrated here. FIG. 3 is only meant to demonstrate that the dynamometers 50 can be disposed so as to measure forces on the tool 52, on the tool holder 56, and on the supporting table 58. It may also be an advantage to use more than one dynamometer at a time to more accurately determine the forces that are applied by the tool 52 to the workpieces 54.

Continuing with FIG. 3, the z-axis forces applied by the friction stir welding mill 60 are controlled by a high-speed servo system 62 that is disposed within the table 58. The servo system 62 enables the top of the table 58 to move up and down to thereby adjust the force applied. The position and configuration of the high-speed servo system 62 shown in FIG. 3 is for illustration purposes only. Those skilled in the art will be familiar with specific placement parameters that are required for correct operation.

However, the placement of the high speed servo system 62 should not be considered limiting. Any other method of modifying the force applied should be considered within the scope of the invention. For example, a high-speed servo system could also be disposed within the tool holder 56 or the arm 64 that is coupled to the toll holder.

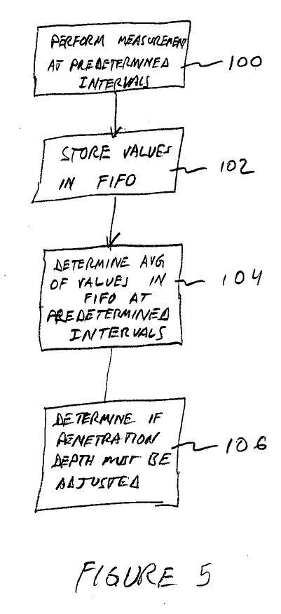

The next aspect of the invention is providing a z-axis laser measurement system. As shown in FIG. 4, a laser micrometer 70 or similar measurement device is disposed on the tool holder 56 of the present invention. The laser micrometer 70 is positioned so that a laser beam 72 strikes the surface 74 of the workpieces 54 just ahead and slightly to one side of the path of the tool 52. The laser micrometer 70 is used to determine the depth of penetration of the tool 52 into the workpieces 54. The depth of penetration is determined because the distance from the laser micrometer 70 to a tip 76 of the tool 54 is known. Thus, with an accurate measurement of the distance from the laser micrometer 70 to the surface 74 of the workpieces 54, it is possible to determine the depth of penetration of the tool 52.

An ideal penetration depth of the tool 52 is determined by the materials being welded, and the particular type of weld that is needed. For example, it has been determined that for many materials, the tool 52 should be approximately 0.005 inches from penetrating through to a bottom surface 78 of the workpieces 54. Thus, the thickness of the workpieces 54 must also be known to a high degree of precision in order to be able to determine how far the tool 52 needs to penetrate the workpieces 54 to the depth that is determined to be most desirable for the particular application and materials involved.

It may not be apparent that the laser micrometer 70 or other measurement system must know the thickness of the workpieces 54 at the actual location of the tool 52. Obviously, the laser micrometer 70 as shown is not determining the distance to the workpiece precisely over the tool 52, but at some offset. Thus, a control system must take into to account this offset when determining how far to raise and lower the tool 52. This is especially important when the surface of the workpieces 54 is relatively rough.

Another aspect of the present invention is a process that should be used with the laser micrometer 70 or any other measurement system that is being used. Simply taking measurements and making adjustments in the penetration depth of the tool 52 into the workpieces 54 is not practical. This is because any single measurement may be an aberration from the expected or the norm.

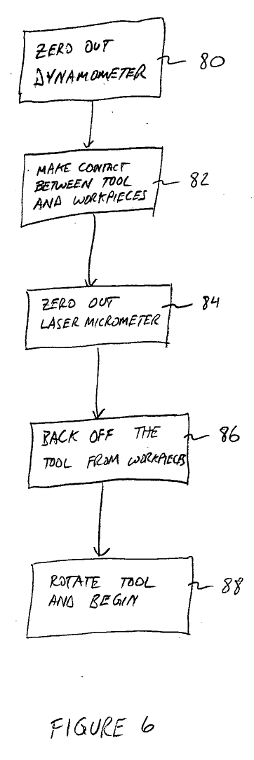

To solve this problem, the present invention provides a method as shown in FIG. 5 of using a first-in, first-out (FIFO) for recording data defined as the distance between the laser micrometer 70 and the surface 74 of the workpieces 54. As presently embodied, a laser micrometer measurement is performed approximately every 10 milliseconds in the first step 100. The measured values are stored in the FIFO in the second step 102. An average value of all the laser micrometer measurement values stored in the FIFO is performed approximately every 2 milliseconds as step three 104. The average distance between the laser micrometer 70 and the surface 74 of the workpieces 54 is then used to determine what adjustments should be made in the penetration depth of the tool 52 using the high-speed servo motors 62 as step four 106.

It is noted that the size of the FIFO or the number of measurement values used in determining the average distance can be adjusted in order to create consistent performance of the friction stir welding mill 60.

It has been determined that deflection of various components of the friction stir welding mill 60 can be relatively large. For example, deflection has been measured to be as large as 0.075 inches from original starting conditions. Thus, in order to maintain the tool 52 at just 0.005 inches from penetrating the workpieces 54, it now becomes apparent why it can be difficult to maintain such precise penetration if the tool can be deflected up and down through the workpieces by such a great distance.

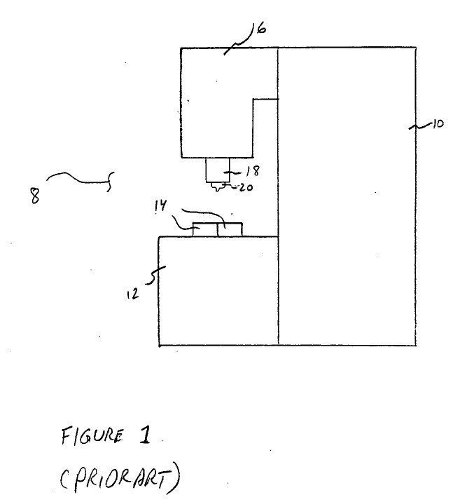

It is important to recognize that in a typical prior art friction stir welding system 8 (FIG. 1), a servo motor control system is not even aware of the deflection that can occur between the tool and the workpieces. Thus as shown in FIG. 3, precise measurements of the distance between the tool holder 56 and the top surface 74 of the workpieces 54 enables the servo motors 62 to compensate for deflection of various components of the friction stir welding mill 60.

It should be recognized that the laser micrometer 70 shown in FIG. 3 can be disposed in other locations on the friction stir welding mill 60. Furthermore, the laser micrometer 70 can also be replaced with any measuring system that can provide at least the same degree of accuracy in measurements. What is important is that measurements can be made to determine a depth of penetration of the tool 52 into the workpieces 54 such that the depth of penetration can be modified quickly and accurately.

Another aspect of the present invention is what will be referred to as an Auto Touch-off Sequence (ATS). An operator of the friction stir welding mill 60 the present invention needs to perform ATS in order to obtain repeatable friction stir welding results. In other words, for the present invention to be practical, it must be able to consistently produce the same weld with the same desirable characteristics.

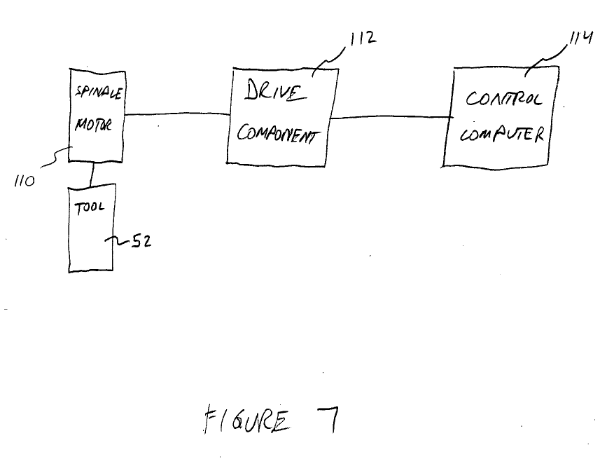

FIG. 6 is a flowchart that describes the step of the ATS. The first step 80 of the ATS is to zero out the dynamometer. Those skilled in the art understand the need to begin with an accurate baseline force reading in order to determine to what degree the forces are changing.

The next step 82 is to bring the tool 52 down to the workpieces 54 (or the table 58 up, or a combination of the two) until the tool 54 makes contact with the workpieces 54. In the friction stir welding mill 60 of the present invention, approximately 10 pounds of force is applied, but this amount may vary greatly depending upon the mill being used. The operator of the friction stir welding mill 60 then holds the tool 52 in this contact position.

The next step 84 is to zero out the laser micrometer 70. It is important to note that this step calibrates the laser micrometer 70, and should thus be performed before every run of workpieces through the friction stir welding mill 60.

The next step 86 is to back-off the tool 52 from the surface of the workpieces 54 some known distance. For example, this can be a distance as relatively small as 0.05 inches. At this point, the next step 88 is to begin the friction stir welding process by bringing up the rotational speed of the tool 52.

The importance of the ATS to calibrate these systems of the present invention should not be minimized, as this calibration truly enables assembly-line like repeatability of the process. If the process cannot be reliably repeated, then the friction stir welding mill 60 will be no more reliable than the prior art.

The next aspect of the present invention is related to tool rotational speed control. It is imperative to keep tool rotational speed as consistent as possible. Variations in tool rotational speed result in an irregular weld.

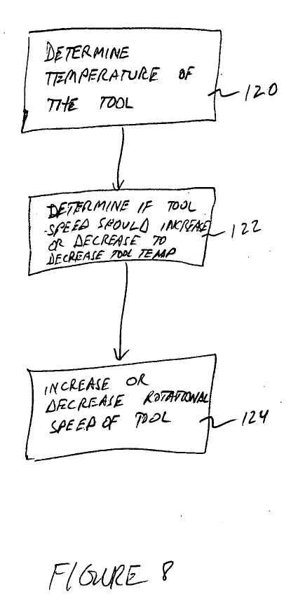

In order to make adjustments in the speed of a spindle motor for the tool 52, it is typical to allow a control computer to make direct adjustments. However, it has been determined that the adjustments to the spindle motor speed would be made too slowly by the control computer to be effective in maintaining consistent tool rotational speed. Accordingly, the present invention uses a drive component 112 that is coupled between the control computer 114 and the spindle motor 110 itself as shown in a block diagram in FIG. 7.

The drive component 112 receives feedback directly from the spindle motor 110, and immediately compensates by increasing or decreasing the speed of the spindle motor without the intervention of the control computer 114. The drive component is thus dedicated in its function to control the speed of the spindle motor 110. In contrast, the control computer 114 is performing a variety of general purposes functions for the friction stir welding mill 60, and will therefore generally not be able to respond as rapidly as is needed to prevent detrimental slowing or speeding up of the spindle motor 110.

Another aspect of the invention is controlling the temperature of the tool 52. Controlling the temperature of the tool 52 is important because of the affect that temperature has on tool life. It has been determined that the temperature of the tool does not always correspond as expected to tool rotation speed. It was expected that increasing rotational speed would always result in an increase in tool temperature. Surprisingly, this is not always the case. There are certain rotational speeds at which the tool increases in temperature, even though the rotational speed of the tool has actually decreased. Accordingly, control of tool temperature may mean increasing the rotational speed of the tool instead of decreasing it as expected.

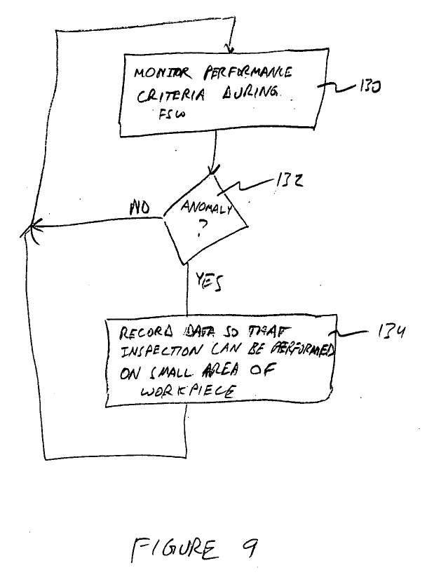

It may be desirable to automatically increase rotational speed in order to decrease tool temperature. It may also be desirable to trigger an audible alarm, or automatically extract the tool. The options will most likely depend upon many factors, such as the material being welded, the material used in the tool itself, the rotational speed of the tool, etc. Thus the first step 120 shown in FIG. 8 is to determine the temperature of the tool 52. The second step 122 is to determine whether to increase or decrease the rotational speed of the tool 52 in order to cause a decrease in temperature of the tool 52. The final step 124 is to increase or decrease the rotational speed of the tool 52.

There are other various aspects of the invention that have been noted as being important to overall performance of the friction stir welding mill 60. For example, the computer controlling operation of the friction stir welding mill 60 provides a single-screen that contains the most important information regarding performance of the system, thereby enabling the operator to make rapid decisions and adjustments when necessary.

Another important feature is the ability to record most of the data being generated by all the components of the friction stir welding mill 60. This recording of data enables evaluation of performance in order to improve techniques for controlling the friction stir welding process.

For example, FIG. 9 is a flowchart of the steps that should be performed. Consider a pipe being welded that must typically be x-rayed in order to confirm reliability of the finished weld. As long as the friction stir welding mill 60 is performing as expected, the step of x-raying may be bypassed in some circumstances, unless unusual conditions were detected during the welding process, such as a temperature spike of the tool 52. Therefore, the first step 130 is to monitor performance criteria of the friction stir welding mill 60. If an anomaly was detected in step two 132, it could be determined where on the workpieces the weld was being performed by recording this information in step three 134, and thus only perform an x-ray or closer inspection of a small section of the pipe after the weld is completed.

Another aspect of the invention is constant velocity control. Hammering and weld variations are the typical result of variations in velocity of the tool 52 as it is moved along a joint between workpieces 54. That includes rotational movement and translational movement of the tool 52. Typical servo systems include hydraulic, AC and DC systems. The present invention uses an AC system in order to obtain “shaped” control of the tool movement.

For example, ramping up the speed of the tool 52 along the workpieces 54 should be accomplished through a shaped control system. Otherwise, hammering can result, and a tool may be broken.

Another aspect of the invention is the application of all of the principles discussed above for workpieces that may not be planar. For example, consider a pipe and the inherently arcuate surfaces that it will have.

Other pipe issues include a clamping system to hold pipes square and butted together when welding sections of pipe together. It is also important o include an anvil that would be kept against the inside of a weld. With a plug weld, the tip of the tool would be made to break off into the hole on a pipe because there is no “run-off” area. A retractable pin could also be used to avoid a hole in the pipe.

Another aspect of the invention is the use of infra-red or ultrasonic tool tracking. These systems would enable the tool to move down the workpieces within a certain distance of the desired weld joint, thus providing for y-axis adjustments.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A friction stir welding mill for welding metal matrix composites, ferrous alloys, non-ferrous alloys, and superalloys, said system comprising:
a table for supporting workpieces to be welded;
a tool holder disposed above the table;
a tool disposed in the tool holder; and
at least one dynamometer disposed so as to be capable of determining a degree of force applied by the tool on workpieces that are to be disposed on the ble.

2. The friction stir welding mill as defined in claim 1 wherein the mill is further comprised of the at least one dynamometer disposed in the table.

3. The friction stir welding mill as defined in claim 1 wherein the mill is further comprised of the at least one dynamometer disposed in the tool holder.

4. The friction stir welding mill as defined in claim 1 wherein the mill is further comprised of the at least one dynamometer disposed in the tool.

5. The friction stir welding mill as defined in claim 1 wherein the mill is further comprised of a high-speed servo system, wherein the high-speed servo system adjusts the degree of force applied by the tool to the workpieces.

6. The friction stir welding mill as defined in claim 5 wherein the mill is further comprised of the high-speed servo system disposed in the table.

7. The friction stir welding mill as defined in claim 5 wherein the mill is further comprised of:
an arm coupled to the tool holder; and
a frame coupled to the arm, wherein the high-speed servo system is disposed in the arm.

8. The friction stir welding mill as defined in claim 1 wherein the mill is further comprised of a laser measurement system for determining a distance between the tool holder and the workpiece, to thereby control position of the tool within the workpiece.

9. The friction stir welding mill as defined in claim 1 wherein the mill is further comprised of:
a spindle motor coupled to the tool for rotating the tool in order to perform friction stir welding; and
a drive component coupled to the spindle motor, wherein the drive component uses feedback from the spindle motor to determine if the spindle motor is changing a rotational speed, and for sending commands to the spindle motor to correct the rotational speed of the spindle motor to thereby maintain a constant rotational velocity of the tool.

10. A method for making improved welds with a friction stir welding mill, said method comprising the steps of:
(1) providing a friction stir welding tool having a superabrasive coating thereon for friction stir welding metal matrix composites, ferrous alloys, non-ferrous alloys, and superalloys;
(2) disposing the friction stir welding tool in a tool holder disposed above a table holding the workpieces; and
(3) providing a dynamometer in the friction stir welding mill such that the dynamometer can determine an amount of force applied by the tool to the workpieces.

11. The method as defined in claim 10 wherein the method further comprises the steps of:
(1) monitoring the amount of force applied by the tool to the workpieces; and
(2) varying the force applied by the tool to the workpieces in accordance with the measured force as determined by the dynamometer, wherein the force is varied in order to keep the force constant that is applied by the tool to the workpieces.
